(19) United States
(12) Patent Application Publication
(10) Pub. No.: US 2008/0005430 A1
(43) Pub. Date: Jan. 3, 2008

(54) COMMUNICATION INTERFACE

(75) Inventors: Ron Kozenitzky, Petah-Tikva (IL); Yanki Margalit, Ramat Gan (IL); Dany Margalit, Ramat Gan (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ALADDIN KNOWLEDGE SYSTEMS LTD., Tel Aviv (IL)

(21) Appl. No.: 11/382,055

(22) Filed: May 8, 2006

(51) Int. Cl. G06F 13/38

(52) U.S. Cl. 710/72

(57) ABSTRACT

In one aspect, the present invention is directed to a communication interface such as a USB and a Firewire, for transferring data between a peripheral and a host, the interface comprising: a first connector, at the host side, through which the host communicates with the peripheral; a second connector, at the peripheral or at an extension cable connected to the peripheral, through which the peripheral communicates with the host upon mating between the first connector and the second connector; a switch coupled to the second connector, the switch operative for modifying a service provided by the peripheral to the host, and/or a modifying a connectivity between the host and the peripheral. According to a preferred embodiment of the invention, the switch does not harm waterproof characteristic of the peripheral.

### FIELD OF THE INVENTION

The present invention relates to the field of communication interfacing. More particularly, the invention relates to an interface, for example, an interface based on USB or Firewire, for connecting a peripheral to a host,

### BACKGROUND OF THE INVENTION

USB (Universal Serial Bus) is a plug-and-play interface between a computer and add-on devices (such as audio players, joysticks, keyboards, telephones, scanners, and printers). It is commonly used for connecting external devices to a computer without adding an adapter card or even turning the computer off. The USB standard was developed by Compaq, IBM, DEC, Intel, Microsoft, NEC, and Northern Telecom.

A USB interface, as any other computerized interface for connecting two devices, comprises two parties which mate upon connection. For the purpose of facilitating the text to follow, one party is referred to herein as host, and the other as a peripheral.

It is an object of the present invention to provide a communication interface between a host and a peripheral, which enables a user to interfere with the service(s) provided by the peripheral to a corresponding host, or the connectivity therebetween.

It is another object of the present invention to provide a more secure USB token than that of the prior art.

It is a further object of the present invention to provide a communication interface between a host and a peripheral, which is coupled with input means at the connector at the peripheral side, but still maintains the waterproofed characteristics of this connector.

Other objects and advantages of the invention will become apparent as the description proceeds.

### SUMMARY OF THE INVENTION

In one aspect, the present invention is directed to a communication interface such as a USB and a Firewire, for transferring data between a peripheral and a host, the interface comprising: a first connector, at the host side, through which the host communicates with the peripheral; a second connector, at the peripheral or at an extension cable connected to the peripheral, through which the peripheral communicates with the host upon mating between the first connector and the second connector; a switch coupled to the second connector, the switch operative for modifying a service provided by the peripheral to the host, and/or a modifying a connectivity between the host and the peripheral. According to one embodiment, the switch may comprise a plurality of states. For example, “open”, “closed”, “state 1”, “state 2”. According to a preferred embodiment of the invention, the switch does not harm waterproof characteristic of the peripheral.

In a preferred embodiment of the invention, the switch is used for adding additional input means to a security token. In this case the switch can be used for signaling to the security token to generate a one-time password.

In another aspect, the present invention is directed to a security token, comprising: a switch at a connector of the security token through which the security token communicates with a host via a communication interface such as USB and Firewire, for modifying a service provided by the peripheral to the host and/or a connectivity between the host and the peripheral. According to a preferred embodiment of the invention, the switch does not harm waterproof characteristic of the peripheral. The switch comprises a plurality of states. In one embodiment of the invention, the switch is operative for signaling to the security token to generate a one-time password.

### BRIEF DESCRIPTION OF THE DRAWINGS

The present invention may be better understood in conjunction with the following figures:

FIGS. 1 and 2 schematically illustrate a USB switch installed on a USB token, according to a preferred embodiment of the invention.

FIGS. 3 and 4 schematically illustrate the operation of the additional functionality provided to the USB connector.

FIG. 5 schematically illustrates a USB switch, according to another preferred embodiment of the invention.

FIG. 6 schematically illustrates a USB switch, according to another preferred embodiment of the invention.

FIG. 7 illustrates a USB switch, according to yet another preferred embodiment of the invention.

FIG. 8 illustrates a USB switch, according to yet another preferred embodiment of the invention.

### DETAILED DESCRIPTION OF PREFERRED EMBODIMENTS

The term “peripheral” refers herein as to a device which provides service(s) to another device, which is referred herein as a “host”. Exemplary peripherals include but are not limited to printers, scanners, and security tokens.

The connection between a peripheral and a host may be through a cable, such as in a printer, or directly, i.e. without a cable, such as in a security token.

The term “USB switch” refers herein to a switch that operates in conjunction with a USB connector.

The term “Interface” refers herein to hardware means (e.g., wires, plugs, sockets, etc.), software means, rules. etc., for communication between one device and another.

A security token, sometimes referred to as authentication token, is a small hardware device carried by an owner thereof in order to perform operations of a security nature, such as authenticating a user, authorizing access to a service (such as network service), one-time password authentication and transaction, key related operations such as encryption, decryption, digital signatures, secured memory, etc. A security token can be used also in one-factor authentication as well as in multi-factor authentication. A Flash memory device, such as Disk-On-Key of M-Systems, is also a security token, since it enables a user to retain data in a secure manner, i.e., out of reach of unauthorized people. A common form factor of a security token is a key fob, which is a portable device.

A USB token is a security token which connects with a system at least via a USB connection. The eToken-Pro and eToken-NG manufactured by Aladdin Knowledge Systems are examples of USB tokens. Also SecurID of RSA Security, and Disk-On-Key of M-Systems are security tokens.

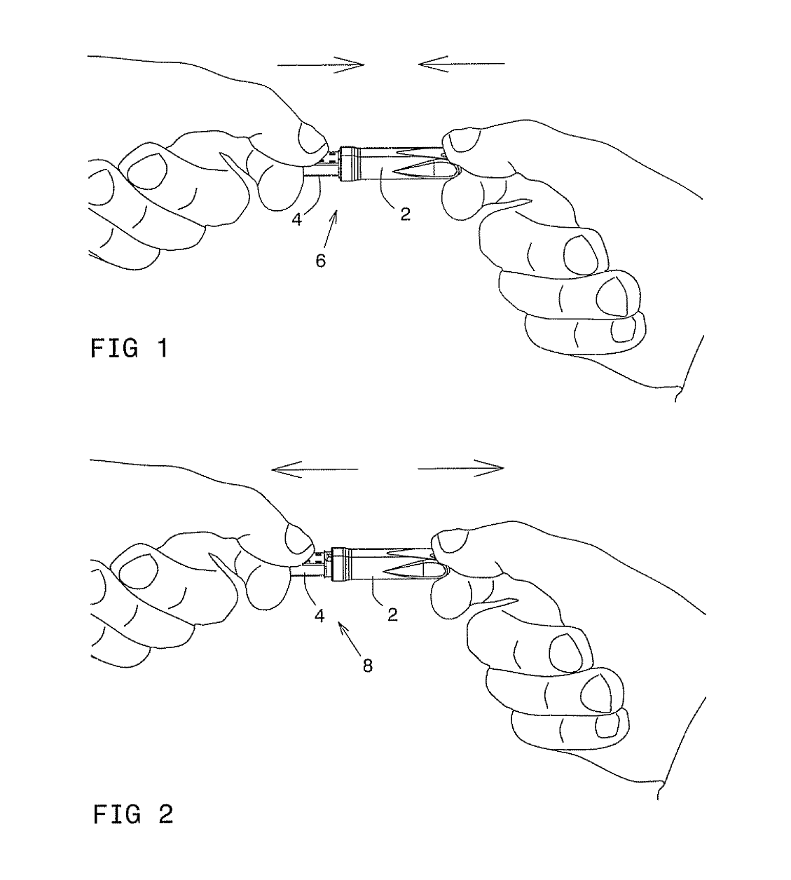

FIGS. 1 to 6 illustrate a USB switch coupled on a USB token, according to a preferred embodiment of the invention. The switch mechanism comprises the contacts 12 and 16; the conductive bar 14 which connects and disconnects the connection between the contacts 12 and 16; the sliding plug 26 which can be moves inside the housing 2.

The USB connector 4 is coupled on a sliding plug 26 that fits closely inside the bore of the casing 2. The mechanism reminds a piston: in general, a piston is a sliding plug that fits closely inside the bore of a cylinder. Similarly, in this case the sliding plug is member 26, which slides inside a “cylinder”, i.e. a corresponding bore of the casing 2.

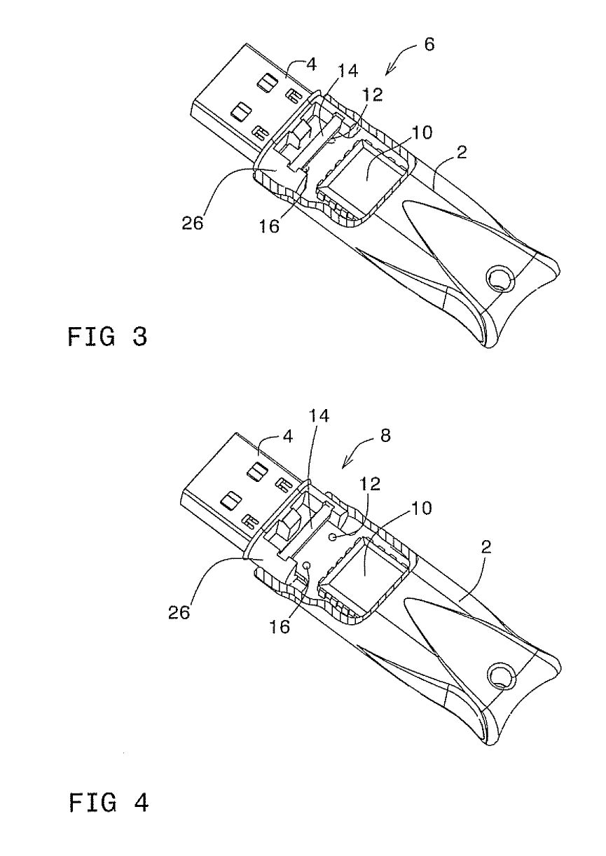

Bar 14 is composed of conductive material. In the “closed” state, as illustrated in FIG. 3, the bar 14 touches the contact points 12 and 16 at the same time, i.e. generate electrical connectivity between the contact points 12 and 16. In the “open” state, as illustrated in FIG. 4, bar 14 there is no electrical connectivity between the contact points 12 and 16.

FIGS. 1 and 3 illustrate the switch in a “closed” state, and FIGS. 2 and 4 illustrate an “open” state.

FIG. 1 schematically illustrates a “closed” state of a USB connector 4 installed of a USB token 2, according to a preferred embodiment of the invention. FIG. 2 schematically illustrates an “open” state of a USB connector 4 installed of a USB token 2, according to a preferred embodiment of the invention.

FIG. 3 schematically illustrate the internal structure of the USB connector illustrated in FIG. 1, according to a preferred embodiment of the invention. FIG. 4 schematically illustrates the internal structure of the USB connector illustrated in FIG. 2, according to a preferred embodiment of the invention.

In contrast to the cylindrical form of a piston, according to a preferred embodiment of the invention the mating elements (members 26 and 2) preferably do not have a circular form, but rather a form which forces the plug to slide in the same position with regard to the bore, such as oval or rectangular form. This way the position of bar 14 with regard to the contacts 12 and 16 is fixed.

Since a USB token is a portable device and attachable to a key fob, it must be designed in such a way that it will resist “hard” conditions. Waterproofing, for example, is an essential requirement of a USB token. For instance, rain drops should not reach to the circuitry inside the token. A security token for military purposes may comply with even higher requirements, for example submersion of a token in a bath of water. According to the embodiment illustrated in FIGS. 1 to 4, the waterproof nature of the USB token 2 is maintained since the piston mechanism doesn't allow water to penetrate into the security token.

The USB switch may be operative to perform an operation such as closing a circuit, signaling to chip 10 or another circuit (not illustrated in the figures) that the user has pressed a switch, etc.

According to a preferred embodiment of the invention, in an interface the switch disconnects the peripheral from the host such that the host is “deceived to believe” that the peripheral is still connected, but no data is actually transferred. For example, in case where the indication that a peripheral is connected to a host is a certain voltage on a certain wire of the interfaced thereof, turning the USB switch on may disconnected the wire from its original connection and connect it to a circuit which generates the expected voltage. Thus, although no data is transferred between the peripheral and the host, the host continues to act like the communication channel is still active.

In a security token used for one-time password authentication, such as the eToken-NG of Aladdin Knowledge Systems, a button is used for signaling the token to generate the next one-time password. Thus, this application uses input means installed on the token.

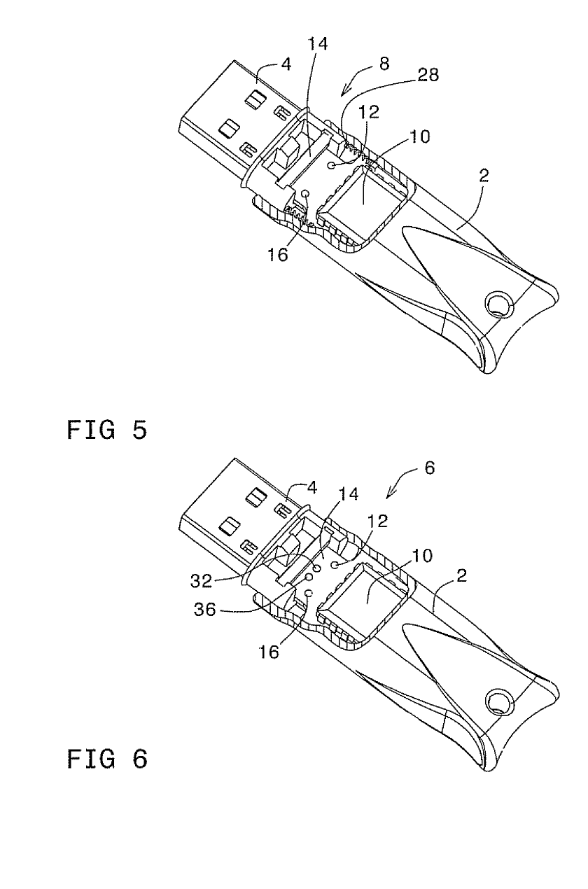

FIG. 5 schematically illustrates the internal structure of a USB switch coupled on a USB token, according to another preferred embodiment of the invention. According to this embodiment, a spring 28 is integrated into the mechanism in order to keep bar 14 away from contacts 12 and 16. When a user turns the USB token on, a LED may light on as acknowledgement to the user thereof, and turned off after a certain time interval (e.g., one second).

FIG. 5 schematically illustrates the internal structure of a USB switch coupled on a USB token, according to yet another preferred embodiment of the invention. The USB switch has three states: In the first state no contact is connected. In the second state contacts 32 and 34 are connected. In the third state contacts 12 and 16 are connected. Each state is distinguishable by the gap between the edge of the contact 4 and the edge of the casing 2.

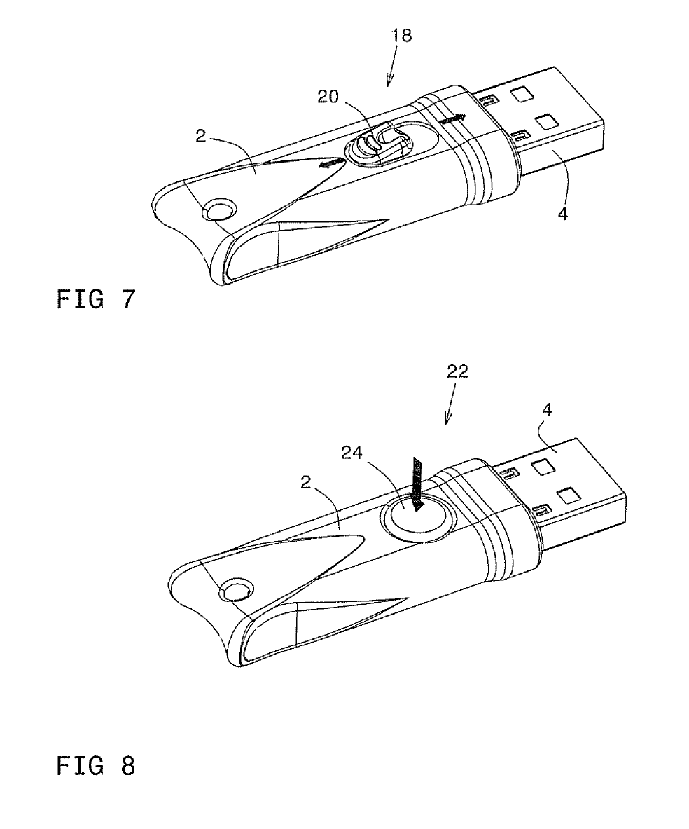

FIG. 7 illustrates a USB switch, according to yet another preferred embodiment of the invention. The switch 20, which has two or more states, is additional to the USB switch described hereinbefore. A usage of the USB switch of FIG. 7 may be, for example, signaling to a system by pushing the casing 2 towards the connector 4, and using the switch 20 for selecting an operation mode, e.g., to signal the USB token to operate as a one-time password, or as an authentication token.

FIG. 8 illustrates a USB switch, according to yet another preferred embodiment of the invention. The switch 24 may return to its position after a user presses it, may remain in its position until a user again presses it, etc.

It should be noted that a USB token is merely an example, and the USB switch can be implemented also in any USB connector, including a USB extension cable.

According to one embodiment of the invention, the token comprises a LED (Light Emission Diode) for providing to a user thereof indication about the operation of the token switch. For example, when the USB channel is active, the LED lights on.

Embedding a button in a security token or any other USB device (i.e., a device connecting to a system via a USB interface) allows increasing the security level of the token. For example, in a network a user gets access to the network by authenticating the user by his token at the beginning of the network communication session. However, since the same token is used for authenticating the user when connecting to his bank account, a malicious object which may take control of the user's computer may enter his bank account during the time the token is connected to the user's computer. The activation switch allows a user to signal the token to be available to the computer only for a limited time period (e.g., 2 minutes) or one authentication session. Thus, after the time period is over, a malicious object cannot enter the user's bank account.

Those skilled in the art will appreciate that the invention can be embodied in other forms and ways, without losing the scope of the invention. The embodiments described herein should be considered as illustrative and not restrictive. It should be noted that although the present invention has been described with regard to a USB protocol, it can be also used with other interfaces, such as Firewire.

1. A communication interface, for transferring data between a peripheral and a host, said interface comprising:
a first connector, at said host side, through which said host communicates with said peripheral;
a second connector, at said peripheral or at an extension cable connected to said peripheral, through which said peripheral communicates with said host upon mating between said first connector and said second connector;
a switch coupled to said second connector, said switch operative for modifying a service provided by said peripheral to said host, and/or a modifying a connectivity between said host and said peripheral.

2. An interface according to claim 1, wherein said switch does not harm waterproof characteristic of said peripheral.

3. An interface according to claim 1, wherein said interface is selected from a croup comprising: a USB interface, a Firewire interface.

4. An interface according to claim 1, wherein said switch comprises a plurality of states.

5. An interface according to claim 1, wherein said peripheral is a security token.

6. An interface according to claim 1, wherein said switch is operative for signaling to said security token thereof to generate a one-time password.

7. A security token, comprising:
a switch at a connector of said security token through which said security token communicates with a host via a communication interface, for modifying a service provided by said peripheral to said host and/or a connectivity between said host and said peripheral.

8. An security token according to claim 7, wherein said switch does not harm waterproof characteristic of said peripheral.

9. An interface according to claim 7, wherein said interface is selected from a group comprising: a USB interface, a Firewire interface.

10. An interface according to claim 7, wherein said switch comprises a plurality of states.

11. An interface according to claim 7, wherein said switch is operative for signaling to said security token to generate a one-time password.
